(19) United States
(12) Patent Application Publication
(10) Pub. No.: US 2009/0276728 A1
(43) Pub. Date: Nov. 5, 2009

(54) Arrangements for Managing Assistance Requests for Computer Services

(76) Inventors: Christopher H. Doan, Austin, TX (US); Trevor Livingston, Austin, TX (US); Praveen P. Hirsave, Austin, TX (US); Venkatesan Ramamoorthy, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 12/114,660

(22) Filed: May 2, 2008

(51) Int. Cl. G06F 3/048

(52) U.S. Cl. 715/810; 715/764

(57) ABSTRACT

In one embodiment, a method for facilitating computer system assistance for system users is disclosed. The method can include receiving a ticket that can indicate an issue to be addressed by the assistance system. The ticket can be associated with a computing asset. The system can search and locate at least one solution to address the issue based on contents of the ticket. The solution can include a video to illustrate a solution to a user and/or the solution can include automated control commands that when selected can actually implement the actions shown on the video in a remote control mode. The solutions can be transmitted to user for user disposition. Other embodiments are also disclosed.

### FIELD

The present disclosure relates generally to computer systems and more particularly to arrangements for managing requests for assistance from users of computer systems.

### BACKGROUND

Many large corporations, entities, and internet service providers have a help desk or service desk function to accept inquiries from employees and/or clients who need help with their computer system. Large scale server business entities, such as a large web hosting system or large data processing system, typically require extensive help desk or technical support to operate efficiently. In fact help/service desk services can be so critical that companies often employ a large staff to operate help desk software and provide such help desk functions. Many types of support applications are commercially available. Some of these applications provide an efficient tool for computer technicians to administrate user requested assistance. Such requested assistance can include system set up, issue resolution and training. Generally, service desk software allows a minimal number of people (often a skilled person such as a technician or an administrator) to receive and log or track requests from users or “customers” regarding acquiring, tracking and disposing of these requests. These requests are commonly referred to as a repair ticket, problem ticket or just a ticket.

Typical service desk software utilizes a workstation with a web browser or other portal program that allows the administrator to access and possibly control the applications, devices and the networks for which the customers often have problems. A service desk system typically is equipped with a “problem ticketing system” where a customer can “fill out” a ticket and provide this ticket to the service desk application and/or the administrator in a paperless manner. These tickets allow service desk personnel to identify problems and priorities and to properly allocate human resources such that tickets can be efficiently processed. A typical service desk system can track pending tickets and processed tickets and can track many other parameters associated with system administration.

A deficient service desk system can cause prolonged outages and cause excessive numbers of outstanding tickets, thereby slowing the work output of numerous employees and reducing productivity for a business entity. Traditional systems that guide a help desk organization in troubleshooting and correcting customer problems are less than perfect.

### SUMMARY

The problems identified above are in large part addressed by the systems, arrangements, methods and media disclosed herein to improve administration of reported computer related issues by providing an increased amount of self help and automated technical assistance for computer users that experience problems. In one embodiment, a method for facilitating semi-automated service desk help for users is disclosed.

It can be appreciated that a quality service desk system is an important tool to facilitate efficient and effective help desk support organization. A support system that only monitors tickets and their disposition generally does hot maximize productivity because it does not provide enough automation for resolving user issues. A user friendly service desk system with self help features may reduce the number of support personnel that are required to provide efficient help desk services.

The disclosed method can include receiving a ticket from a user where the ticket describes an issue to be addressed by the assistance system. The ticket can be associated with one or more computing assets of the user. The computing assets can be hardware or software operated by or associated with the user. The system can accept problem keywords on the ticket and can search and locate at least one solution to address the issue described or defined by the ticket. The solutions located by keyword searching can be displayed to the user as selectable solutions. In some embodiments the solution can include a video to illustrate how internal setting of the users system can be made or changed. In some embodiments the solution can include automated control commands that when selected can automatically implement the change of settings on the users machine. The video of the step by step process for making system setting changes can track the actual changes made in the system settings by the automated control commands. The user can first play the video, viewing command that can be performed and the results of implementing the commands and determine if implementing the solution is desirable. Then, the user can select an auto-implementation of the commands where the user's machine can be “auto-configured.” Such an auto-configuration occurs when the control commands are made on the users assets. Thus, solutions can be browsed, located, selected from a library of solutions and when selected by the user the solutions can be transmitted to the user's machine for user viewing and implementation.

In another embodiment, a system is disclosed to administrate and assist in the process of disposing of problem tickets based oh user define problems, complaints and/or inquiries related to a computer system. For example, the complaints and/or inquiries can be a query into how to set up a system, how to change the way a system operates and/or how to correct an actual or perceived, problem with operation of the system. The system can include a ticket facilitator module to accept user input regarding a perceived issue and the ticket facilitator module can create a ticket. A system asset/configuration module can create an asset file that defines at least a portion of the user's assets (i.e. hardware and software) and the parameters of the assets (how the system is connected, what software is loaded, the versions of the loaded software etc.).

The asset file can be associated with the user and the ticket. Accordingly, solutions can be located that are tailored to, or are a known fix for, a particular issue, a particular asset, an asset configuration or any combination thereof. In addition, when a technician is addressing a problem and creating a solution, an audio/video/command capture module can capture and store audio, video and commands associated with the audio, video and actions which the technician uses to implement a corrective action(s). A technician can then link this “captured solution” to one or more issues, problem types, assets, asset configurations, etc. via links and associations. Such an audio/video capture can operate similar to many of the video screen capture applications that are commercially available. One such application is AutoScreenRecorder from Wisdom Software Inc.

Further, an issue/problem mapping module can utilize the ticket and the asset file to locate a solution related to the ticket. Such mapping can be created manually based on manually entered links or on historical data indicating solutions that work for problems or the mapping can be done based on keyword searching/browsing. In some embodiments new tickets can be linked to already processed tickets and where the processed tickets are linked to a solution that was successfully implemented. The ticket facilitator can facilitate transmission of audio, video and control commands to a user asset based on a user locating and selecting the solution via a network, or based on an automated or semi-automated problem-solution matching process. In some embodiments, a quality control monitor can track a success rate of the solution locating process and can track the success rate of the solution after it is implemented. In other embodiments, a ticket facilitator can create links from a new ticket to one or more successfully processed tickets or archived tickets based on related issues (i.e. problem definition and asset configuration). The ticket facilitator can also provide a user with solutions to fulfill the requirements of the ticket, including an option to play video and an option to implement an automated corrective action.

In another embodiment, a machine-accessible medium containing instructions to operate a processing system is disclosed which, when executed, can stimulate a machine to provide an automated solution to a user machine based on user created queries. The machine can be caused to receive a ticket indicating an issue to be addressed, where the ticket can be associated with at least one computing asset. The machine can search databases to locate at least one solution to address the issue. The located solution(s) can have an audio component, a video component and an automated control command component.

The machine can transmit the at least one solution to the user where the user's issue can be resolved in an automated or semi-automated fashion. In some embodiments, the machine can accept user input to create the ticket and can query the user to get the appropriate details to sufficiently define the problem or narrow the issue. In some embodiments, the machine can locate an archived ticket and can associate a current ticket with the archived ticket if the issue of the current ticket (and possibly the asset file) has a link or similarities to one or more issues/problems identified by the archived ticket. In some embodiments, the machine can display possible solutions to the user and the user can select one or more possible video solutions, remote control solutions, or video with remote control solutions to satisfy their requirements.

### BRIEF DESCRIPTION OF THE DRAWINGS

Aspects of this disclosure will become apparent upon reading the following detailed description and upon reference to the accompanying drawings in which like references may indicate similar elements:

FIG. 1 depicts a high-level block diagram of an assistance request management system;

FIG. 2 illustrates a graphic user interface for a menu driven assistance request ticket system; and

FIG. 3 is a flow diagram of a process for administrating user queries into computer system operation.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. In some embodiments, a system, method and tangible program for administrating user queries into computer system operation is disclosed.

In general, the disclosed system can record human interactions (audio, video and control commands) provided by a technician when the technician is resolving an issue with a computer system. In a typical situation, the technician can utilize a graphical user interface of the computer system to open menus and select options to change how the system is set and how the system operates, thus addressing an issue. Such a change in configuration/operation can resolve one or more issues or problems that a user is having with a computer system. These recorded human interactions can be assigned to, or linked to, one or more problem(s) and/or solution(s) and to various hardware, software and hardware/software configurations. Accordingly, issue and problem keywords can be assigned to audio, video and command files contained in a solutions library such that a user issue having a keyword can locate one or more solutions. In some embodiments a user can search the solutions library using one or more keywords that describe assets, issues, problems and symptoms, to name a few.

Keywords can be linked where solution keywords may indicate a type of system and problems or issues that the solution can address. Thus, using keywords, the solutions library which contains audio, video and control commands, can be browsed by a user as the user attempts to find a solution for one or more issue(s)/problem(s). Many different links can be created between problems, issues, audio solutions, video solutions, auto control solutions and different types of systems. In addition, the system can create different kinds of links between problems and/or solutions and different hardware and software versions. The links can be assigned a success level where the type of link can indicate if the solution has been very successful at addressing the issue, works sometimes, is plausible to try, of simply will not work. Thus, when the same, similar or a related problem arises, a computer user can search for a recorded solution using keywords that may fix the current issue.

When a possible solution is located, details about the solution can be selected and the user can gather more information as to whether the solution may resolve the user's issue. In one embodiment, without changing any setting on the user's computer, the video of the solution can be played to the user and the user can determine if this solution is proper for the user's issue before the user actually selects the auto commands to make the change to the user's system.

Thus, when a video that emulates how to implement a possible solution is selected by a user, video can be downloaded from a solutions repository to the user's machine and the user can view the “steps” of the recorded interactions that constitute a solution to the issue. Audio can accompany the video, explaining each step, possibly giving the user instructions, pointers, advice and additional solution options. At any time while the video is being displayed, the user can choose to pause or discontinue the viewing, and can manually perform one or more of the interactions/actionable tasks provided in the video. Alternatively, the user can select, at any time, to view/pause the video and/or to implement/apply a set or subset of automated commands to the user's computer. In such an embodiment, the control commands can be associated with what is being displayed oil the video. Implementing such automated commands can change the settings on the user's computer and can address the user's issues with minimal user input.

Accordingly, a user can address an issue or solve a problem in a semi-automated fashion with the “self-help” provided by the system. It can be appreciated that manually configuring the computer may take numerous keystrokes and intricate mouse interaction, but the disclosed semi-automated procedure may take only minimal user input. In addition, the disclosed semi-automated problem solving system typically only requires minimal user knowledge of how to address the problem, and possibly no knowledge of how to actually implement a solution. The automated commands or actionable tasks can be synchronized with the video playback, or the commands can be asynchronous. Asynchronous control can allow a user to select automated control before, during (possibly in steps) or after the video is played. Accordingly, such user friendly controls allows the user to choose whether each automated command is invoked or applied simultaneously as each task is displayed by video. This configuration also allows a user to activate the automated commands before viewing the video, after viewing a portion of the video, or after viewing the entire video.

In some embodiments, when the video is playing, the system has the ability to invoke system operations on the environment. For example, when the video is being displayed, the actual changes via automated commands can be made to the Windows® registry. The Windows registry generally, is a database in the host system which stores settings and options for the operating system for Microsoft Windows. For a registry change, the automated commands can result from an action to open a register edit (reg-edit) routine, where the system can navigate in the registry and can locate a registry key. A value of the registry key may be changed or set, and then the reg-edit routine could be closed/exited. Further, invoking system operations on the environment may be grouped as operating system related changes, or application/user interface based operations. Video for solutions to issues for applications and user interface based operations could utilize website replay and/or a rich text format based technology for implementing the video portion of the system.

The video capture and display and automated commands could utilize standard widgets or native widgets in a JAVA environment. A widget generally is a standardized on-screen representation of a control that may be manipulated by the user. Scroll bars, buttons, and text boxes are examples of widgets that can be copied from a library and placed into a graphical user interface. Widgets could also be utilized for mouse and keyboard activity capture, replay and command implementation. It can be appreciated that actual, pre-selected tasks or previously implemented control commands within one system, can be implemented within another system with the same or similar problems, and such tasks can be implemented after a “dress rehearsal” where the user reviews available or possible future commands and learns possible results and consequences before the user actually selects and invokes commands that will make changes to the user's system.

When this automated self help system is invoked within a service desk application, a user can select solutions stored by the network and assign solutions to devices that are connectable to the network. Solutions may be similar in that they solve the same issue for different versions of related software (i.e. software versions for different platforms or software versions from different time periods). For example, a user may have a similar operating system or application on a laptop computer, a personal digital assistant and a desk top computer, and via a single device, all devices could be chosen for the same or a similar configuration change.

It can be appreciated that the “control command based video solution” may solve one identified issue on one machine which is related to other issues (or other repair tickets) on another machine. Thus, a link or association between issues and solution (solution-to-solution, issue-to solution, issue-to-issue) can be displayed to a user, and a user could select a solution or multiple solutions that can be invoked on all systems that are associated with the “other tickets.” As stated above, the control commands and video can be invoked on any and all computing related devices, including smart phones, personal digital assistants, laptops, or any device with a processor.

One commercially available service desk application is Maximo® which is available from International Business Machine Corporation (IBM). Maximo is known as a strategic asset and service management system that can run on a number of databases including Oracle®, SQL Server® and IBM Database Two (IBM DB 2). Maximo is currently in use by a wide variety of organizations ranging from municipal and county governments, to corporations and government contractors. Maximo is a trademark owned by IBM. Stated differently, the Maximo suite of applications can be viewed as an enterprise asset management, service management and information technology asset management suite of applications that are scalable and easily integrated into existing enterprise resource planning (ERP) systems.

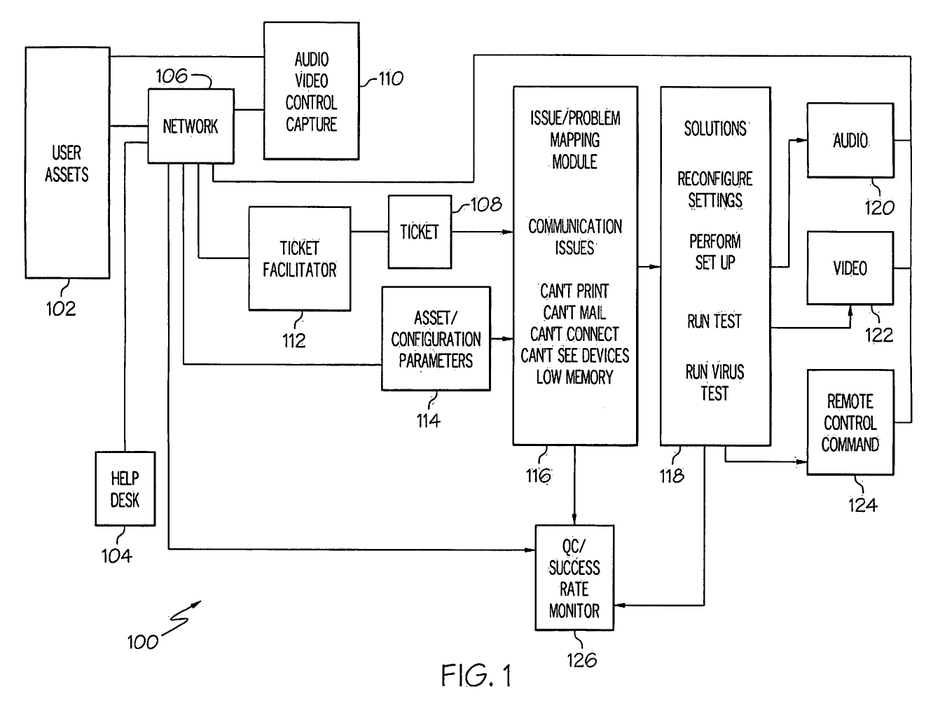

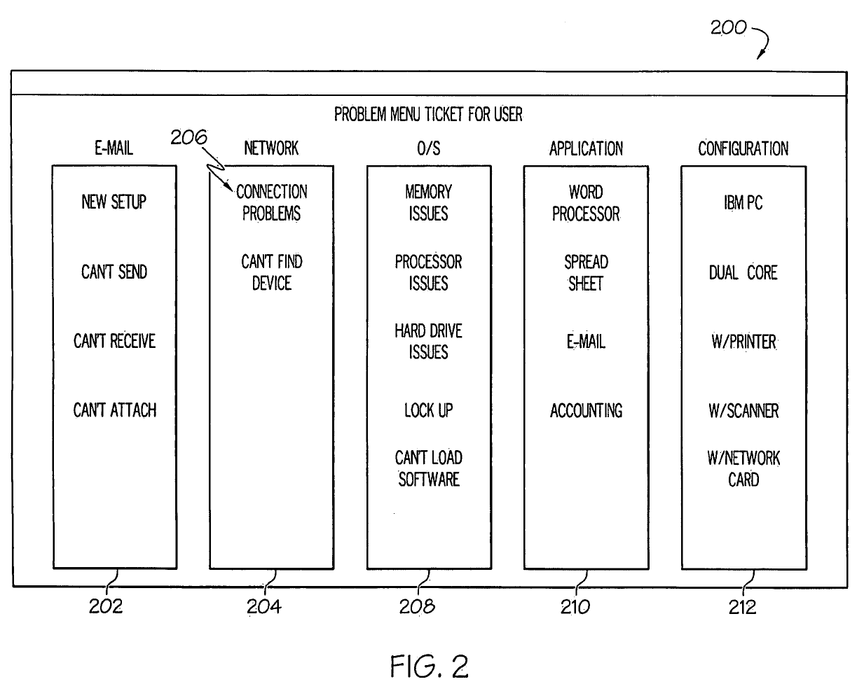

Referring to FIG. 1, a computer services administrative system 100 is depicted. The system 100 could be a system that operates similar to a Maximo asset management application, but with many additional features. The system 100 can include user assets 102 and a help desk station 104 connected via network 106. The help desk station 104 can run an application that can access, monitor and control most devices connected to the network 106. If a user of the user assets 102 needs help, experiences a problem, needs something set up, or needs some form of technical assistance, the user can generate an issue or problem ticket 108 utilizing ticket facilitator module 112. As will be described with respect to FIG. 2, the ticket 108 can be created utilizing a menu driven input/query system as provided by the ticket facilitator 112.

The ticket facilitator 112 can provide a graphical user interface format for acquiring data from the user where the graphical user interface can have multiple layers of queries to assist the user in accurately defining their assets and issues. If the user is experiencing specific types of problems, the ticket facilitator 112 can query the user for symptom data, or for error messages that have been displayed to the user. The ticket facilitator 112 may also ask the user to perform specific steps to acquire additional detail data about the user's issue or problem. User assets 102 could be a personal computer, a server, a personal digital assistant, a smart phone, or any computing device that can communicate and any software that is loaded on the user's system.

A system asset/configuration module 114 can generate or provide a list of assets and possibly configurations (hardware and software) that defines or quantifies the user's assets 102. In some embodiments, the ticket 108 can be a file that includes the asset configuration data. The asset configuration data can define a type of device such as a specific brand of personal digital assistant, and can define a specific version of an operating system with a specific revision level, and can define specific applications loaded onto the device. In another embodiment, the asset configuration data for a ticket might include what type of computer, what operating system, what version of code that is installed, and what devices are connected to the user's computer.

The issue/problem mapping module 116 can contain links or associations between a problem and one or more solutions and between a solution and multiple, problems that the solution will address. For example, the user's ticket 108 may specify a communication issue, a printing issue, an inability to access something, an e-mail issue etc., and each of these problems can be mapped to a solution by the issue/problem mapping module 116.

Some embodiments may not utilize a menu driven ticket input, but may allow a user to fill in a ticket solely with text that describes a problem. In this embodiment, the issue/problem mapping module 116 may use relational textual tools such as synonym plug-ins and spelling plug-ins, to create a keyword list for mapping text based tickets to solutions. This feature allows for issues and/or problems, to be identified using a uniform list of common keywords to describe the user's problem and to locate a solution. Each problem identified by the issue/problem mapping module 116 can be mapped to, or associated with, one or more solution(s) in solutions database 118. For example, a particular e-mail send/receive issue can be mapped to a solution of reconfiguring a send and, receive server setting in an e-mail application. The solution in solutions library 118 can have video teachings and automated commands that can set parameters, or variables of an operating system can change settings for a particular application. Each solution in the solutions database 118 can be mapped to audio files 120, video files 122, and remote control files 124 where each file is selectable by a user.

It can be appreciated that if a user does not know how to properly configure a system, or has problems, they can fill out a problem ticket 108 and the asset configuration data can be automatically attached to the ticket 108. The issue/problem mapping module 116 can locate a solution in the solutions database 118 and can automatically retrieve and transmit audio files 120, video files 122 and remote control files 124 to the user assets 102 that are tailored to addressing the user's issues. In some embodiments, these files 120, 122 and 124 can also be transmitted back to the ticket facilitator module 112, which can prompt the user via user system/user assets 102 about implementing a fix for the problem. The quality control/success rate monitor 126 can log the hit rate and success rate of solutions and/or solution to problem links.

After a user is presented with the solution files (i.e. from 120, 122 and 124), the user can be queried by the user assets 102 to determine if the user wants to be provided with an audio/visual presentation of the solution regarding how a user could interface with their asset/device to solve the problem associated with the ticket 108. The user can also be prompted to determine if the user wants the ticket facilitator 112 to take over control of the user assets 102 where the ticket facilitator 112 can automatically implement the solution in a remote control fashion. Thus, the user can select whether the ticket facilitator 112 provides just video, just audio, or just takes control to implement changes. Such changes can include modifying system settings on the user's machine or user assets 102. In some embodiments, the user can search the solutions library/database 118 using keywords of other contents of the ticket 108 to see what potential solutions exist for each problem.

Thus, over time system 100 will have numerous solutions stored in the solutions library and the system can have well established links between the issues and problems and solutions. If a newly generated ticket 108 describes the same or a similar issue(s) or problem(s), the newly generated ticket 108 can be associated with one or more archived tickets and solutions. Accordingly, new tickets can be compared to archived tickets and can be associated with archived tickets based on keywords and other similar user inputs and similar asset configurations. A solution can include audio, video, and commands that have been previously recorded by audio/video/command capture module 110. Such a record can be made from someone's actual “mechanical” actions utilized to address an issue or correct a problem. The capture of audio and video can be performed in a manner similar to many commercially available video screen capture applications. Capture of the commands and implementation of the commands can be performed similar to how a remote control desktop application operates but should not require real time input by a human on the remote end or from the master controller.

These recorded mechanical actions can track a technician's input to the system via pointing device interactions and keyboard interactions. The technician input can be captured by audio visual control capture module 110 to create and record a set of commands and actionable video associated with the commands. The commands and video can be linked to, or associated with, one or more issues or problems defined by a ticket in the issue problem mapping module 116. Thus, a problem that is sufficiently defined by a ticket 108 can automatically prompt retrieval of a video from video module 112 and a command file from command module 124 that can be played or played back via the user's assets 102 associated with the appropriate ticket(s) 108. In some embodiments, the system 100 can provide a cascading mechanism for process replication. The playback of the identified solution can occur on an asset that is peripheral to the main computing device that generates the ticket 108. For example, the corrective action may occur on a piece of hardware, such as a printer, which is defined by a user's asset file.

In some embodiments, a first case manual (not automated) remote control session that solves or fixes a known problem by downloading code can be recorded (audio, video and commands) and saved as a solution by audio video control capture module 110. The video recording can be played back and used by many different users to “recreate” the steps to implement that solution. A default solution for many serious problems may be to save important data and reload software or possibly to restore the system from a back up source. The “action” video can playback the instruction commands and actions performed by the recorded solution. Therefore, users who subscribe to the same solution can have the same actionable video “played back” on their system to solve the same or similar problem.

Referring to FIG. 2, a graphical user interface 200 for allowing a user to create a problem ticket is depicted. The user can create the problem ticket using a pointing device such as, for example, a mouse in coordination with a graphical user interface. Accordingly, a user can select an issue or type of problem that the user is having or has experienced. Many different issues or problems and/or classifications of issues and problems can be displayed by the graphical user interface 200 and these displayed issues and problems or classes of issues and problems can be selected by the user.

The graphical user interface 200 allows the user to describe an issue or a problem by selecting items via a menu driven acquisition system, where the user input can detail a user assistance request related to a problem being experienced by the user. Some inputs by the user can trigger additional prompts by the system as the system harrows that problem and acquires symptoms. Accordingly, the system can force a user to “drill down” to the root of a problem by providing various menus which have more specific queries as the menu drills down. Thus, the system can attempt to create tickets that have sufficient detail such that the problem is easy to understand and this can increase the probability that the retrieved solution will address the issue/fix the problem.

For example, if a user is experiencing an e-mail issue, the user can select something in the e-mail window 202 and the system can ask the user if there is a send/receive issue, a document attaching issue or the system can query the user to determine that the user just wants to know how to change a setting, such as requiring a spell check before each e-mail is sent. Network window 204 allows for the user to select a type of network problem such as network connection problem 206. Operating system window 208 allows a user to select ah issue related to their operating system such as memory allocation functions, processor and hard drive issues, as well as lock up problems and problems associated with loading software.

Application window 210 allows for a user to report an issue related to applications, such as word processing applications, spread sheet applications, e-mail applications and accounting applications. Finally, configuration window 212 can allow the user to verify their asset configuration file and to report an issue related to each of the pieces of hardware in the file. Each ticket can be associated with an individual user or a user's system/asset(s) and each ticket can include data regarding the user's asset. A user's asset (for example, a personal computer) can be referred to as a configuration item (CI) asset, and the user's peripherals, operating system code and applications can be referred to as a collection of CI/assets.

It can be appreciated that a ticket can be generated for a problem or a query when a user merely needs some support information. In some embodiments, the user can select an icon on their desktop and such a selection can “pop-up” the disclosed ticket generator in graphical user interface 200. If the query on the ticket is a case of first impression, then the ticket can be considered a “pioneer ticket” and a technician can be located to generate an audio, video and control command solution which can be stored in a solutions library. The solution can be linked in a relational manner, possibly using a relational database to one or more types of queries or one or more tickets. A ticket that has a query describing a problem that has been solved can be archived. When it is determined that a new, unresolved ticket has similarities to an archived ticket, this new ticket can “subscribe” to, or be associated with, one or more archived tickets.

In some embodiments, recorded video and solutions may not be specific to or specifically linked to a particular type of device, computer system or operating system. For example, the system could be utilized to manage user queries regarding smart phones and personal digital assistants. Some solutions that are appropriate for personal computers may be appropriate for these devices, possibly with minor modifications. In some embodiments, before a video and corrective control is available for subscription, propagation, or distribution it may go through an empirical validation phase. This phase can include a ranking process that accepts input from administrators, technicians and users. Such a process can monitor the success of a solution for a particular query/problem, or can monitor user selections of a solution and the system can also obtain user feedback on the results utilizing a questionnaire. Different types of feedback and different strengths of feedback can be utilized to rate a solution generally, and to rate or rank a solution and the link between the problem and the solution.

In some embodiments, the quality control system can award a single merit point to a solution and to a problem solution link when the solution provides successful disposition of the query based on the problem described by the ticket. If a selected/implemented “solution” creates problems, one or more points can be deducted from the solution and/or the corresponding link. The ranking system could monitor a selectable button such as an “undo button” that would allow a user to undo the changes if the solution did not work or if implementing the solution made undesirable changes. Use of such a button by a user could prompt subtracting a merit point and could prompt additional survey questions to be utilized by the quality control system.

In some embodiments, a rating or ranking threshold can be established or assigned by an administrator where a solution is not available as a self serve option unless the solution has proven some success. Once a given rank threshold has been reached by the solution, the system could automatically tag the solution or the problem solution link as approved for user selection, distribution or automated propagation to asset configurations that are known to have a problem.

In some embodiments, solution applications can be in a textual format and in some embodiments the solutions could be downloaded, obtained or imported from others such as application providers or third party providers. For example, software patches, service packs and new software versions and their download can be stored as an entire or partial solution. The control command files could invoke accessing an internet site where the appropriate code can be located and downloaded to the user's asset which generates the ticket or has an open ticket.

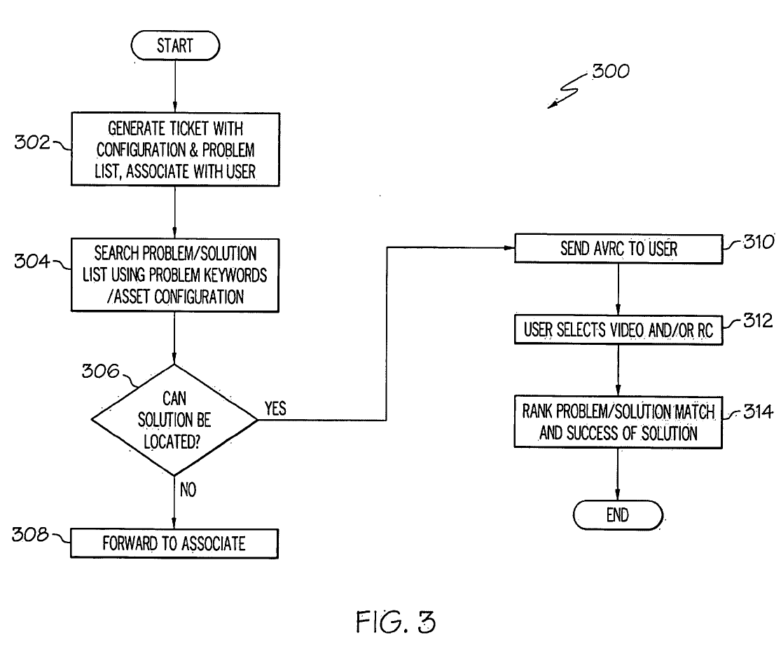

Referring to FIG. 3, a flow diagram 300 disclosing methods for administrating tickets for a computer system is disclosed. As illustrated by block 302, a ticket can be generated and received. The ticket can have an asset configuration list and at least one query such as a problem or a question list. In some embodiments, the ticket can be associated with a user. As illustrated by block 304, the ticket can be utilized to search a problem/solution list or database. As illustrated by decision block 306, it can be determined if a solution can be located. If a solution cannot be located, then the ticket can be forwarded to an associate or a technician at a help desk as illustrated by block 308.

As illustrated by block 310, if one or more solutions can be located, then the audio visual remote control solution can be sent to a machine or asset associated with the ticket. The solution(s) and their various formats (i.e. audio, video and commands) can be displayed to a user via selectable buttons. The user can decide whether to select a particular solution and to select one or more formats for learning about implementing the Solution or actually implementing the solution, as depicted in block 312. As illustrated by block 314, the solution as it is applied to each problem can be ranked based on its success. This can be achieved by monitoring user behavior or via feedback manually provided by the user, possibly in the form of a survey. It can be appreciated that multiple issues/symptoms/problems can be solved by a single solution and that different solutions can solve the same problem. Some combinations can be more successful and/or more efficient than others and the ranking system could acquire such information and utilize such information to improve overall system performance. The process can end thereafter.

An implementation of the process described above may be stored on, or transmitted across, some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data.

Computer storage media includes, but is not limited to, RAM, ROM, EEPROM, flash memory or Other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable, media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

Each process disclosed herein can be implemented with a software program. The software programs described herein may be operated on any type of computer, such as personal computer, server, etc. Any program may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet of other networks. Such signal-bearing media, when carrying computer-readable, instructions that direct the functions of the disclosed arrangements, represent embodiments of the present disclosure.

The disclosed embodiments can take the form of an entirely hardware embodiment, an entirely software embodiment or an embodiment containing both hardware and software elements. Some embodiments can be implemented in software, which includes but is not limited to firmware, resident software, microcode, etc. Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times that code is retrieved from bulk storage during execution.

Input/output or I/O devices (including but not limited to keyboards, displays, pointing devices, etc.), can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A method comprising:
receiving a ticket, wherein the ticket indicates an issue to be addressed, and wherein the ticket is associated with at least one computing asset;
locating at least one user selectable solution to address the issue, wherein the at least one user selectable solution has user selectable video and user a selectable automated command; and
transmitting the at least one user selectable solution to the at least one computing asset.

2. The method of claim 1, further comprising displaying the at least one user selectable solution.

3. The method of claim 2, wherein a configuration of the at least one computing asset is automatically changed in response to a selection of the automated command.

4. The method of claim 2, wherein video is automatically displayed in response to a user selection of the user selectable solution.

5. The method of claim 1, further comprising tracking a history of the at least one user selectable solution to determine a success level of the at least one user selectable solution.

6. The method of claim 1, further comprising recording human to machine interactions associating keywords with the recorded interactions and storing the recording in a solutions library.

7. The method of claim 1, further comprising creating a ticket utilizing a menu.

8. The method of claim 1, wherein the locating of the at least one user selectable solution comprises keyword searching.

9. The method of claim 1, further comprising linking the ticket to an archived ticket and to a solution associated with the archived ticket.

10. The method of claim 1, further comprising acquiring user input regarding a success of implementing the user selectable solution.

11. A system comprising;
a ticket facilitator to create a ticket based on user input regarding a system issue;
an asset identification module to associate at least one asset parameter with the ticket;
a video acquisition and storage module to capture and store video representing interaction that can provide corrective actions to address the system issue;
a control command acquisition and storage module to capture and store control commands, the control commands to implement corrective actions related to the system issue; and
a mapping module to utilize the ticket and the at least one asset parameter to locate a solution related to the system issue and to locate video and control commands to address the system issue.

12. The system of claim 11, further comprising a quality control monitor to track a success of located solutions as related to the system issue, wherein the quality control monitor accepts user input.

13. The system of claim 11, wherein the mapping module links system issues to solutions.

14. The system of claim 13, wherein the links are created utilizing keywords.

15. A machine-accessible storage medium containing instructions to operate a processing system which, when the instructions are executed by a machine, cause said machine to perform operations, comprising;
receiving a ticket, wherein the ticket, indicates an issue to be addressed and wherein the ticket is associated with at least one computing asset;
locating the at least one solution to address the issue, wherein the at least one solution has video and control commands; and
transmitting the at least one solution to the at least one computing asset.

16. The machine-accessible storage medium of claim 15, further comprising instructions, which, when executed cause the machine to accept user input to create the ticket.

17. The machine-accessible storage medium of claim 15, further comprising instructions, which, when executed, cause the machine to locate an archived ticket and associate the ticket with an archived ticket if the issue has similarities to an issue on the archived ticket.

18. The machine-accessible storage medium of claim 15, further comprising instructions, which, when executed, cause the machine to display the at least one solution and to acquire a user selection of one of a video solution, a remote control solution, or a video with remote control solution, to address the issue.

19. The machine-accessible storage medium of claim 15, further comprising instructions, which, when executed, cause the machine to rank the at least one solution based on a successes history attributed to resolving issues by the at least one solution.

20. The machine-accessible storage medium of claim 15, further comprising instructions, which, when executed, cause the machine to accept user input regarding a users success with implementing the at least one solution.
